(19) United States
(12) Patent Application Publication
(10) Pub. No.: US 2015/0231872 A1
(43) Pub. Date: Aug. 20, 2015

(54) CAMOUFLAGE PATTERN AND METHOD FOR GENERATING CAMOUFLAGE PATTERN

(71) Applicant: Scott Eustice, Janesville, MN (US)

(72) Inventor: Scott Eustice, Janesville, MN (US)

(21) Appl. No.: 14/185,513

(22) Filed: Feb. 20, 2014

(51) Int. Cl. B32B 38/14; B32B 3/10

(52) U.S. Cl. CPC B32B 38/14; B32B 3/10

(57) ABSTRACT

A camouflage pattern and method for making camouflage patterns that includes interposing a secondary image or layer of images over a primary image or layer of images. In some embodiments, the primary image or layer of images may comprise one or more images of natural scenery elements. In some embodiments, the secondary image or layer of images may comprise one or more images of United States service members. The secondary image or layer may be interposed over the primary image or layer such that the secondary image or layer of images become part of the primary image or layer of images, appearing obscured, faint, or ghostly within the primary layer. The resulting overlay of images may be used as a camouflage pattern to be placed on or incorporated into a variety of articles of manufacture.

### FIELD OF THE INVENTION

The present disclosure relates to camouflage patterns and methods for generating camouflage patterns. Particularly, the present disclosure relates to a method of incorporating secondary images into unrelated primary camouflage patterns. More particularly, the present disclosure relates to interposing secondary images over unrelated primary images of natural scenery elements to create camouflage patterns.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Conventional camouflage patterns may be placed on or incorporated into any number of objects. In some cases, the camouflage pattern is placed on or incorporated into the object so as to prevent or minimize detection in a certain environment. Military personnel may use camouflage patterns on clothing, vehicles, combat or training gear, or other equipment in order to prevent or minimize detection in natural environments. Hunters, fishers, bird watchers, campers, paintball players, and others may similarly use camouflage patterns on clothing or equipment to prevent or minimize detection in a variety of surroundings. In other cases, the camouflage pattern may be placed on or incorporated into apparel or other objects for a novelty or aesthetic effect.

Some conventional camouflage patterns may include the use of blocks or splashes of color which are in a color scheme designed to match the coloring of a natural environment and which may be placed randomly or in a pattern. Other camouflage patterns may include the use of photographs or computer-generated images of natural scenery or elements of a natural environment. Some conventional patterns may incorporate natural elements so as to create a complete natural scene, such that the camouflage is meant to simulate natural scenery. For example, U.S. Pat. No. 8,420,206 (Bernegger) discloses a camouflage pattern that is designed to imitate an underwater scene. The Bernegger camouflage pattern employs the use of natural elements such as fish, water, corals, and other natural elements consistent with an underwater environment which are blended together to imitate an underwater scene. The Bernegger camouflage is a novelty camouflage that may be incorporated into a variety of manufactured objects, but the pattern is comprised of scenes, particularly underwater scenes. The Bernegger camouflage does not combine unrelated image elements. Instead, any images used in the Bernegger camouflage pattern are consistent with the intended underwater scene.

There is a need in the art for a camouflage pattern and method of making a camouflage pattern that combines secondary images with unrelated primary images in a manner that recognizes or commemorates the secondary images. In addition, it would be beneficial to have a camouflage pattern and method of making a camouflage pattern that honors United States heroes. Particularly, a camouflage pattern and method of making a camouflage pattern that honors military service members, such as members of the army, navy, air force, marines, coast guard, or other military personnel, as well as civil service members, such as firefighters, police officers, or other emergency or enforcement personnel would be beneficial. More particularly, it would be beneficial to have a camouflage pattern and method of making a camouflage pattern that incorporates images of United States heroes and related images into a natural setting, so as to incorporate such images into the camouflage pattern and to recognize or commemorate those heroes.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to a camouflage pattern, having a primary layer of one or more images, and a secondary layer of one or more images that are unrelated to the image(s) of the primary layer, wherein the secondary layer is interposed with the primary layer, such that the secondary layer image(s) are colored and composed so as to substantially blend into the primary layer, although the second layer images remain at least partially visible. The primary layer may have one or more images of natural elements, which may be trees, driftwood, leaves, grass, branches, twigs, rocks, water, sand, or snow. In some embodiments, the secondary layer may include one or more images of or related to United States service members, such as army personnel, navy personnel, air force personnel, marines personnel, coast guard personnel, firefighters, and police officers. In some embodiments, the secondary layer may have one or more images related to service in World War I, World War II, the Vietnam War, Gulf War, or War in Afghanistan.

The present disclosure, in another embodiment, relates to an article of manufacture having an outer surface, the outer surface incorporating a camouflage pattern, having a primary layer with one or more images, a secondary layer with one or more images inconsistent with the image(s) of the primary layer, wherein the secondary layer is interposed with the primary layer, such that the secondary layer image(s) are colored and composed so as to substantially blend into the primary layer, although the secondary layer image(s) remain at least partially visible within the primary layer. In some embodiments, the article may be clothing, fabric, equipment, or a vehicle. The primary layer of the camouflage pattern on the outer surface may have one or more images of natural elements, which may be at least one of trees, driftwood, leaves, grass, branches, twigs, rocks, water, sand, and snow. In some embodiments, the secondary layer of the camouflage pattern may include one or more images of or related to United States service members, such as army personnel, navy personnel, air force personnel, marines personnel, coast guard personnel, firefighters, or police. In some embodiments, the secondary layer may have one or more images related to service in World War I, World War II, the Vietnam War, Gulf War, or War in Afghanistan.

The present disclosure, in still another embodiment, relates to a method of making a camouflage pattern, which includes obtaining a primary image or set of images, obtaining a secondary image or set of images unrelated to the primary image(s), and digitally interposing the secondary image or set of images within the primary image or set of images, such that the secondary image or set of images are blended into the primary image or set of images, although the secondary image or set of images remain at least partially visible within the primary image or set of images, resulting in a new image. The primary image or set of images may have one or more images of natural elements, which may be trees, driftwood, leaves, grass, branches, twigs, rocks, water, sand, or snow. In some embodiments, the secondary image or set of images may include one or more images of or related to United States service members, such as army personnel, navy personnel, air force personnel, marines personnel, coast guard personnel, firefighters, or police officers. In some embodiments, the secondary image or set of images may have one or more images related to service in World War I, World War II, the Vietnam War, Gulf War, or War in Afghanistan.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 illustrates one embodiment of a camouflage pattern of the present disclosure.

FIG. 2 illustrates a primary layer of images according to one embodiment of a camouflage pattern of the present disclosure.

FIG. 3 illustrates one image that may be incorporated into a primary layer of images according to one embodiment of a camouflage pattern of the present disclosure.

FIG. 4 illustrates one image that may be incorporated into a primary layer of images according to one embodiment of a camouflage pattern of the present disclosure.

FIGS. 5-8 illustrate various images that may be incorporated into a secondary layer of images according to one embodiment of a camouflage pattern of the present disclosure.

FIG. 9 illustrates another embodiment of a camouflage pattern of the present disclosure.

FIG. 10 illustrates one image that may be incorporated into a secondary layer of images according to one embodiment of a camouflage pattern of the present disclosure.

FIG. 11 illustrates a portion of a primary layer of images into which the secondary layer image of FIG. 10 may be interposed, according to one embodiment.

FIG. 12 illustrates one image that may be incorporated into a secondary layer of images according to one embodiment of a camouflage pattern of the present disclosure.

FIG. 13 illustrates a portion of a primary layer of images into which the secondary layer image of FIG. 12 may be interposed, according to one embodiment.

### DETAILED DESCRIPTION

The present disclosure relates to novel and advantageous camouflage patterns and methods for generating camouflage patterns. Particularly, the present disclosure relates to a method of interlaying or interposing secondary images over a first primary image or layer of images, such that the interposed images blend into or with the first image or layer of images. The resulting overlay of images may be used as a camouflage pattern to be placed on or incorporated in apparel; hunting, fishing, bird watching, camping, or paintballing gear; vehicles; or any other object on which a camouflage pattern may be placed or incorporated.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

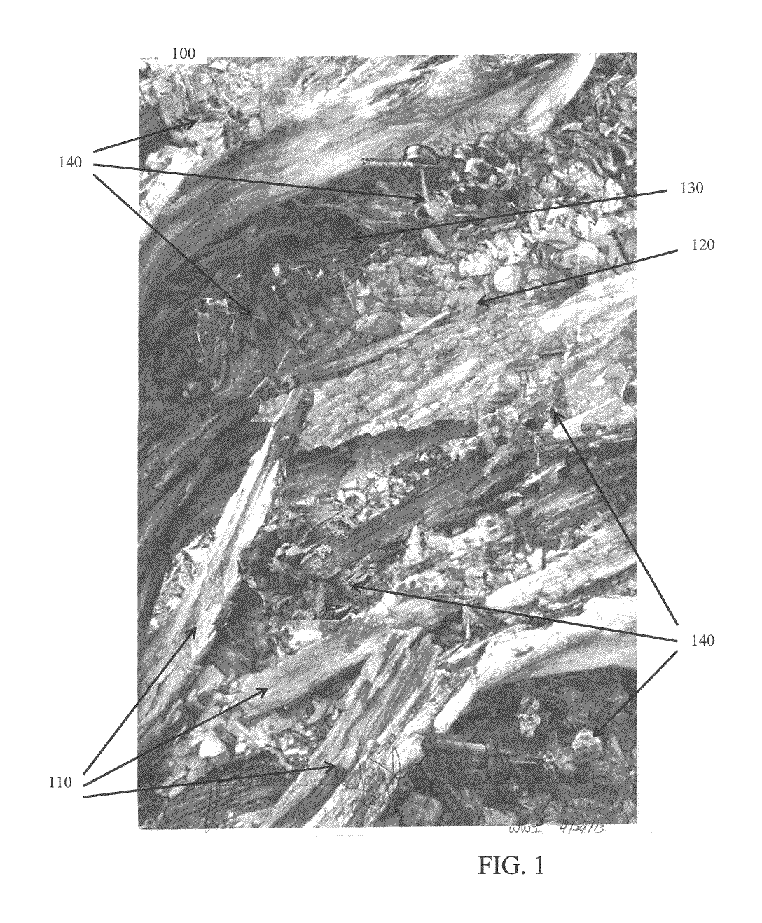

FIG. 1 depicts one embodiment of a camouflage pattern 100 of the present disclosure. A camouflage pattern 100 of the present disclosure may generally be constructed by interposing or interweaving layers of images. A first or primary layer may include one or more images of, or related to, a natural environment or natural elements, such as trees, driftwood, leaves, grass, branches, twigs, rocks, water, sand, snow, or other elements of a natural landscape. The one or more images may be selected to create a specific color scheme or landscape theme, or based on any other theme. The first layer may comprise, for example, a single repeating image, or may include multiple images pieced, combined, or interposed together in any suitable fashion. In one embodiment, as shown in FIG. 1, a first layer of images may include images of driftwood 110, leaves 120, and twigs 130 that may be combined into a single repeating or random pattern. A secondary layer of one or more images may be interposed, blended with, worked into, or interlaced into the first layer of images to form a completed camouflage pattern of the present disclosure. The secondary layer image(s) may generally be inconsistent with or unrelated to the first layer image or images. That is, the secondary layer may include images that are, for example, not commonly found in the natural environment to which the images of the first layer relate. Or, for example, the secondary layer may include images that are disproportionate in size to the first layer images, or images that are inconsistent in color with the first layer images. The secondary layer of images may also include images that are positioned in ways that are inconsistent with or unrelated to the positioning of the primary layer images. Specifically, the image(s) of the first or primary layer and the image(s) of the secondary layer may not be intended to form or simulate a natural scene or natural event. The secondary image(s) may be blended in a manner so as to avoid making it look as though the secondary images are in their original or natural setting. For example, as shown in FIG. 1, the secondary layer of images may include people, objects, or symbols related to United States service members 140. United States service members may include military personnel such as army, navy, air force, marines, coast guard, or other military personnel. United States service members may also include civil service members such as firefighters, police officers, or other emergency or enforcement personnel. Of course the secondary layer of images may not be limited to images of service members, but may include any images. Generally, however, the image(s) of the secondary layer may be unrelated to or inconsistent with the image(s) of the primary layer.

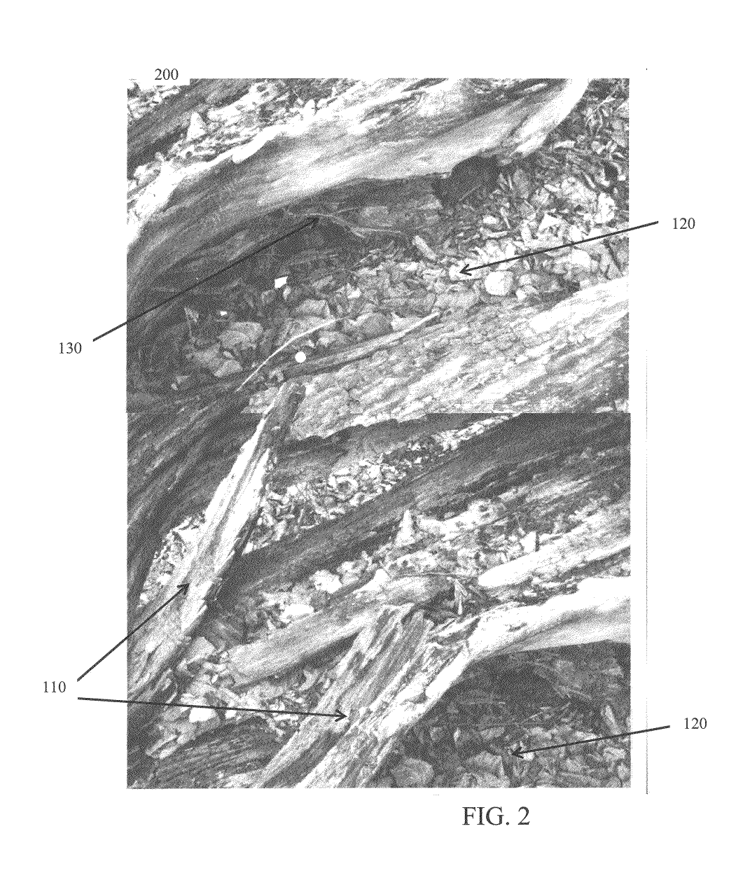

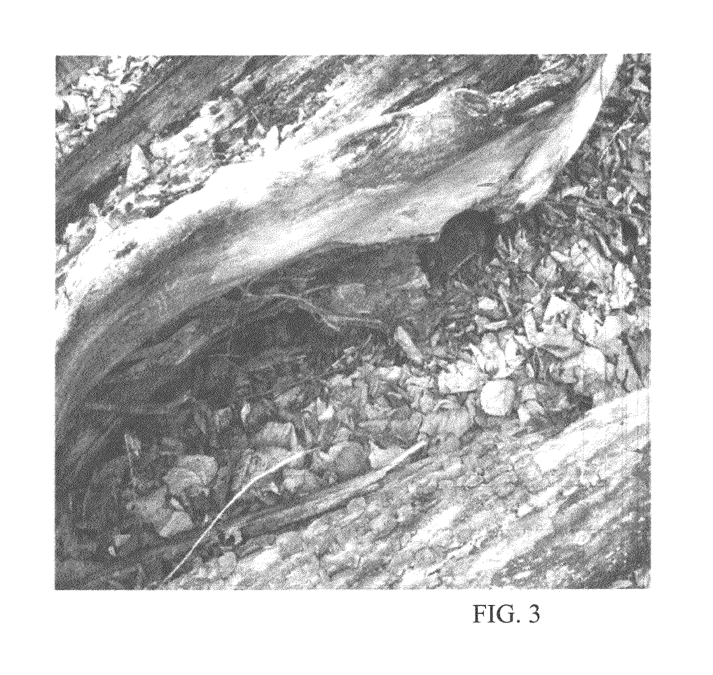

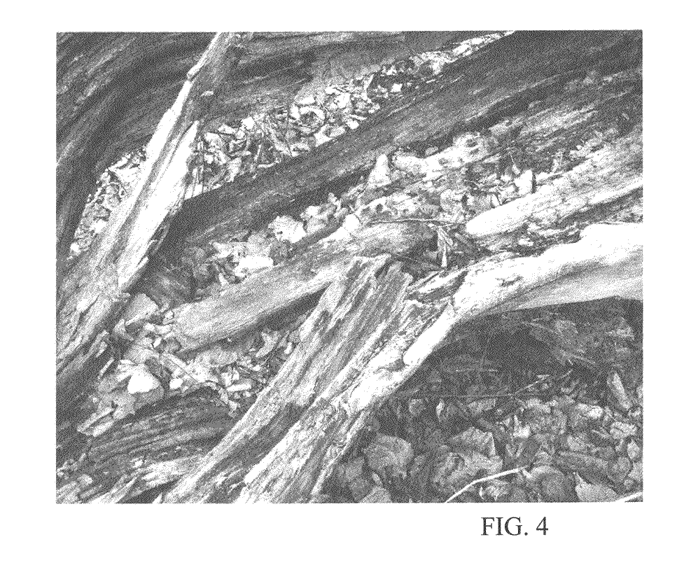

FIG. 2 depicts an example of first layer images 200 blending to form the camouflage pattern 100 of FIG. 1. In one embodiment, a first layer of images may include images of driftwood 110, leaves 120, and twigs 130. In some embodiments, the images of the first layer may be combined in a repeating pattern. In other embodiments, they may be arbitrarily interposed with one another. The first layer of images may be designed to imitate a particular environment or type of natural scenery, such as, but not limited to, a forest, swamp, desert, or other environment. In one embodiment, the first layer may include a photograph or photographs, or selected portions thereof, of natural elements. In other embodiments, the first layer may include two-dimensional or three-dimensional images of natural elements that are drawn, painted, computer-generated, or otherwise simulated to appear natural. The first layer of images may relate to seasonal settings, and may include seasonal colors or other variations. The first layer of images may comprise one or more images. FIG. 3 illustrates one example original image that may be incorporated into a first layer of images such as the first layer of images 200 of FIG. 2. FIG. 4 illustrates yet another example original image that may be incorporated into the first layer of images such as the first layer of images 200 of FIG. 2. The images of FIG. 3 and FIG. 4 may be combined or blended in any suitable manner to form the first or primary layer of images such as the first layer of images 200. The color, texture, or other characteristics of the primary layer images may be altered, or other special effects may be used, to create a desired look or pattern among the first layer.

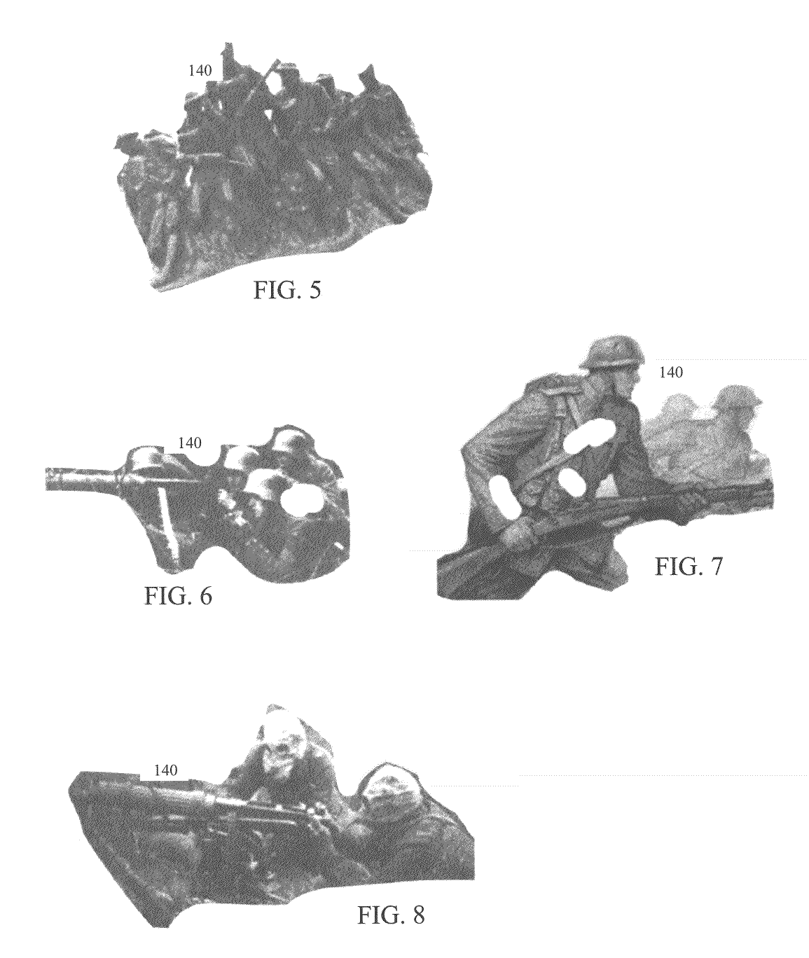

FIGS. 5-8 depict example images that may be used in a secondary layer of images of a camouflage pattern 100 of the present disclosure. FIGS. 5-8 include images 140 of and/or related to United States service members. Of course, as stated above, the image(s) of the secondary layer could include any images that may generally be unrelated to or inconsistent with the image(s) of the first layer. As can be intentionally faintly seen in FIG. 1, each of the one or more images of the secondary layer may be interlaced or interwoven into the first layer. The image(s) of the secondary layer may be placed within or among the first layer image(s) such that the secondary layer images become partially obscured, ghosted, blended, or hidden, etc. within the first layer. The secondary layer image(s) may be interlaced or interposed within the natural scenery elements of the first layer image or images. The secondary layer images may become part of the scenery elements of the first layer images, but the secondary layer images may generally remain visible as separate unrelated images, maintaining their individual structures, although appearing ghostly, faintly, or as shadowy figures. The colors, textures, and/or other characteristics of the secondary layer image(s) may be altered to correspond to the colors, textures, and/or other characteristics of the first layer image(s), however, such is not required. Thus, images of, for example, United States service members or other images of the secondary layer may become part of the camouflage patterns of the present disclosure, as they are blended into the natural elements of the first layer.

In some embodiments, the secondary layer image(s) may incorporate a theme relating to a particular war, battle, geographic location, branch of service, or other theme. The images of FIGS. 5-8, for example, which are part of the secondary layer of images for the camouflage pattern 100 of FIG. 1, relate to a World War I theme, depicting military service personnel and other images related to World War I. A theme among the secondary layer images may be generally inconsistent with or unrelated to the first layer image(s). That is, the first layer image(s) may incorporate natural or scenery elements, or any other images, that are not necessarily related to or generally found within the theme among the secondary layer image(s). Other secondary layer themes may relate to, for example, the Vietnam War, World War II, the Gulf War, the War in Afghanistan, U.S. Army, U.S. Navy, U.S. Air Force, U.S. Marines, U.S. Coast Guard, firefighters, police officers, or even non-service related themes or text-based themes.

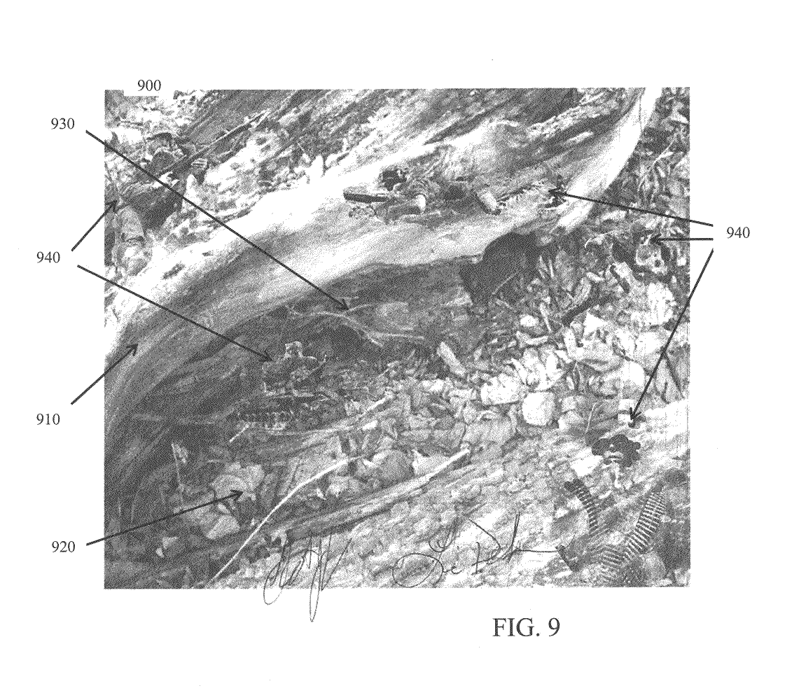

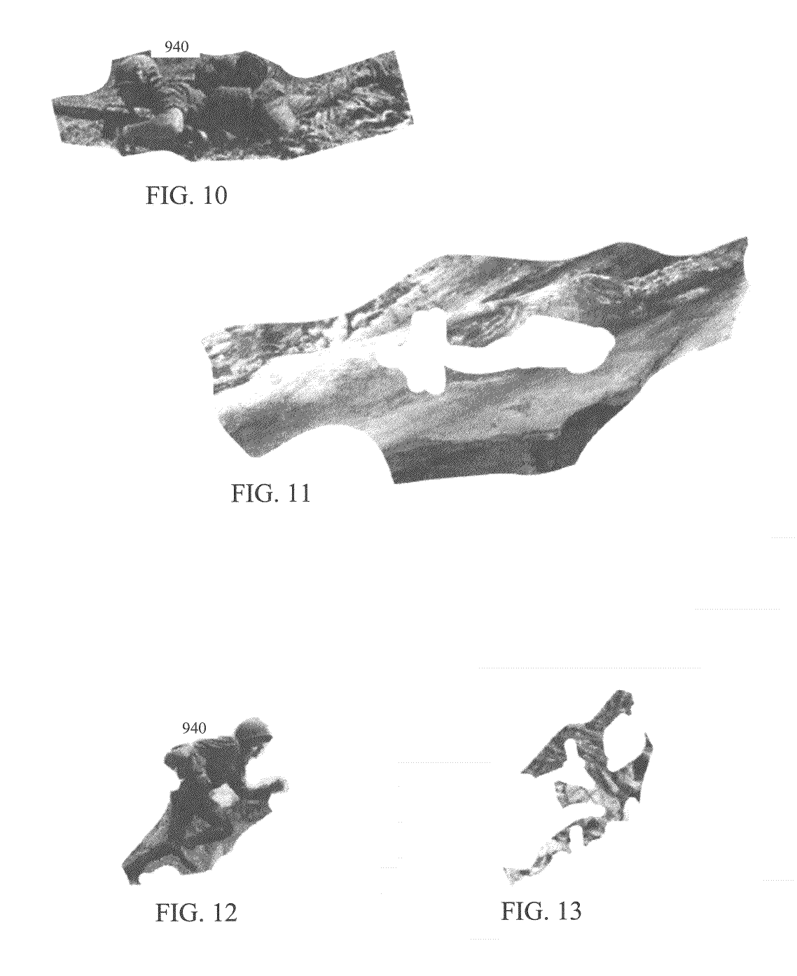

FIG. 9 depicts another embodiment of a camouflage pattern 900 of the present disclosure. FIG. 9 may comprise, in part, a first or primary layer of one or more images incorporating such natural elements as driftwood 910, leaves 920, and twigs 930. FIG. 9 may also comprise a secondary layer of one or more images 940 unrelated to or generally inconsistent with the image(s) of the first layer. As shown in FIG. 9, a secondary layer of images may incorporate, for example, a Vietnam War theme. The images of the secondary layer may be interposed within the first layer image(s), such that the secondary layer image(s) becomes part of the scenery elements of the first layer, but generally maintains its individual structure. The secondary layer image(s) may generally remain visible as a separate unrelated image, although appearing ghostly, faintly, or as a shadowy figure within the first layer image(s). FIG. 10 depicts one example image 940, for example of a United States service member, found in the secondary layer of images of the camouflage pattern 900 of FIG. 9. FIG. 11 depicts a portion of the first layer of camouflage pattern 900 in which FIG. 10 may be interwoven so as to blend the image 940 within the first layer. FIG. 12 depicts another example image 940, for example of a United States service member, found in the secondary layer of images of the camouflage pattern 900 of FIG. 9. FIG. 13 depicts a portion of the first layer of camouflage pattern 900 in which FIG. 12 may be interwoven so as to blend the image 940 within the first layer.

Computer hardware configured with photograph editing software may be used to form a primary or secondary layer of images. The computer and software may be used to blend one or more first layer images together by, for example, altering colors, textures, sizes, positioning, and/or other characteristics, to form a repeating or random pattern. Similarly, the process of interposing a secondary layer within a primary layer may be performed through the use of photograph editing software. The computer hardware and software may be used to obscure or blend the secondary layer image(s) among the first layer image(s) such that the secondary layer image(s) appears, for example, ghostly, faintly, or as a shadowy figure within the first layer image(s). Computer hardware configured with photograph editing software may be used to alter colors, textures, sizes, positioning, and/or other characteristics of an image or images of the primary or secondary layers.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

Photograph editing software of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. In the context of this disclosure, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Once made, the camouflage pattern of the present disclosure may be printed on, transferred to, or woven into any item or substrate via any suitable image transfer, printing, or weaving method. The camouflage pattern of the present disclosure may be incorporated into, placed on, or woven into apparel; hunting, fishing, bird watching, camping, or paintballing gear; vehicles; or any other object or substrate on which a camouflage pattern may be placed, incorporated, or woven.

As described above, the present disclosure relates to novel and advantageous camouflage patterns and methods for generating camouflage patterns. Particularly, the present disclosure relates to a method of interlaying or interposing a secondary image or layer of images over a primary image or layer of images, such that the interposed image or images blend into or with the first image or layer of images. The secondary layer images may become part of the first layer images, but the secondary layer images may generally remain visible as separate unrelated images, maintaining their individual structures, although appearing ghostly, faintly, or as shadowy figures. In particular embodiments, a camouflage pattern may be created using the methods of the present disclosure in order to honor military service members, such as members of the army, navy, air force, marines, coast guard, or other military personnel, as well as civil service members, such as firefighters, police officers, or other emergency or enforcement personnel. The resulting overlay of images may be used as a camouflage pattern to be placed on or incorporated in apparel; hunting, fishing, bird watching, camping, or paintballing gear; vehicles; or any other object on which a camouflage pattern may be placed or incorporated.

In the foregoing description, various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A camouflage pattern, comprising:
a primary layer comprising one or more images; and
a secondary layer comprising one or more images unrelated to the one or more images of the primary layer;
wherein the secondary layer is interposed with the primary layer, such that the one or more images of the secondary layer are colored and composed so as to substantially blend into the primary layer, although the one or more images of the secondary layer remain at least partially visible within the primary layer.

2. The camouflage pattern of claim 1, wherein the primary layer comprises one or more images of natural elements.

3. The camouflage pattern of claim 2, wherein the primary layer comprises one or more images of one or more of trees, driftwood, leaves, grass, branches, twigs, rocks, water, sand, and snow.

4. The camouflage pattern of claim 1, wherein the secondary layer comprises one or more images of or related to United States service members.

5. The camouflage pattern of claim 4, wherein the secondary layer comprises one or more images of at least one of United States army personnel, navy personnel, air force personnel, marines personnel, coast guard personnel, firefighters, and police officers.

6. The camouflage pattern of claim 1, wherein the secondary layer comprises one or more images related to service in at least one of World War I, World War II, the Vietnam War, the Gulf War, or the War in Afghanistan.

7. An article of manufacture having an outer surface, the outer surface incorporating a camouflage pattern, comprising:
a primary layer comprising one or more images; and
a secondary layer comprising one or more images inconsistent with the one or more images of the primary layer;
wherein the secondary layer is interposed with the primary layer, such that the one or more images of the secondary layer are colored and composed so as to substantially blend into the primary layer, although the one or more images of the secondary layer remain at least partially visible within the primary layer.

8. The article of claim 7, wherein the article is one of clothing, fabric, equipment, and a vehicle.

9. The article of claim 7, wherein the primary layer comprises one or more images of natural elements.

10. The article of claim 9, wherein the first layer comprises one or more images of at least one of trees, driftwood, leaves, grass, branches, twigs, rocks, water, sand, and snow.

11. The article of claim 7, wherein the secondary layer comprises one or more images of or related to United States service members.

12. The article of claim 11, wherein the secondary layer comprises one or more images of at least one of United States army personnel, navy personnel, air force personnel, marines personnel, coast guard personnel firefighters, and police officers.

13. The article of claim 7, wherein the secondary layer comprises one or more images related to service in at least one of World War I, World War II, the Vietnam War, Gulf War, and War in Afghanistan.

14. A method of making a camouflage pattern, comprising:
obtaining a primary image or set of images;
obtaining a secondary image or set of images unrelated to the primary image or set of images; and
digitally interposing the secondary image or set of images within the primary image or set of images, such that the secondary image or set of images are blended into the primary image or set of images, although the secondary image or set of images remain at least partially visible within the primary image or set of images, resulting in a new image.

15. The method of claim 14, wherein the primary image or set of images comprises one or more images of natural elements.

16. The method of claim 15, wherein the primary image or set of images comprises images of at least one of trees, driftwood, leaves, grass, branches, twigs, rocks, water, sand, and snow.

17. The method of claim 14, wherein the secondary image or set of images comprises one or more images of or related to United States service members.

18. The method of claim 17, wherein the secondary image or set of images comprises one or more images of at least one of United States army personnel, navy personnel, air force personnel, marines personnel, coast guard personnel, firefighters, and police officers.

19. The method of claim 14, wherein the secondary image or set of images comprises one or more images related to service in at least one of World War I, World War II, the Vietnam War, Gulf War, and War in Afghanistan.
